(19) United States
(12) Patent Application Publication
(10) Pub. No.: US 2022/0172295 A1
(43) Pub. Date: Jun. 2, 2022

(54) SYSTEMS, METHODS, AND DEVICES FOR AGGREGATING AND QUANTIFYING TELEMATICS DATA

(71) Applicant: Metropolitan Property and Casualty Insurance Company, East Providence, RI (US)

(72) Inventors: Michael Grandy, Cary, NC (US); Luigi Fava, Warwick, RI (US); Yun Ji, Cary, NC (US); Benjamin Alan Perryman, Raleigh, NC (US)

(21) Appl. No.: 17/108,577

(22) Filed: Dec. 1, 2020

(51) Int. Cl. G06Q 40/08; G07C 5/08

(52) U.S. Cl. CPC G06Q 40/08; G07C 5/08

(57) ABSTRACT

In one embodiment, a system receives vehicle state data that includes directions and speeds of movement of a vehicle over a plurality of time periods, and determines a set of maneuvers performed by the vehicle over the plurality of time periods based on the vehicle state data. Each maneuver can represent a transition from a first state to a second state in a specified time period. The system also aggregates portions of the vehicle state data for each maneuver of the set of maneuvers to generate maneuver data, and determines maneuver characteristics based on the maneuver data, where the maneuver characteristics include motion information. The system further generates a safety score associated with a user of the vehicle based on the maneuver characteristics for each maneuver.

### TECHNICAL FIELD

The present disclosure generally relates to telematics, and more specifically to aggregating telematics data and classifying vehicle operations.

### BACKGROUND

The science of telecommunications and informatics, or telematics, can be used in a variety of applications such as, for example, controlling remote devices, tracking objects, autonomous driving, vehicle safety management systems, vehicle risk assessment systems, navigation systems, usage-based automotive insurance systems, among others. Generally, data about an object, such as a vehicle, can be collected and analyzed to monitor the object, monitor a usage of the object, manage certain aspects of the object, etc. For example, sensors capturing information about the location, movement, state, etc., of a vehicle can be collected and analyzed to track the vehicle, control the vehicle, monitor a usage of the vehicle, and/or determine various characteristics of an operation of the vehicle such as, for example, safety and/or risk. However, the amount of data collected about an object can be increasingly large and difficult to analyze, particularly in larger and/or more complex applications such as vehicle applications. Moreover, the difficulty of processing the data collected about an object and making accurate and intelligent calculations based on the collected data can increase as the amount and complexity of data collected grows. In many telematics applications, it is significantly difficult to filter or scale the collected data in an accurate and/or intelligent manner.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example telematics environment showing a telematics system that communicates with various devices over a network in accordance with some examples of the present disclosure;

FIG. 2 illustrates a schematic diagram of an example telematics device, in accordance with some examples of the present disclosure;

FIGS. 3A and 3B illustrate schematic block diagrams of examples of a telematics system and vehicle, in accordance with some examples of the present disclosure;

FIG. 4 illustrates a schematic block diagram showing example maneuver-level data segments generated from streams of telematics data collected for a vehicle during a trip, in accordance with some examples of the present disclosure;

FIG. 5 illustrates a schematic block diagram showing maneuver-level features identified for maneuver-level data segments determined for a trip, in accordance with some examples of the present disclosure;

FIG. 6 illustrates a schematic block diagram showing a maneuver identified for a trip and a context associated with the maneuver, in accordance with some examples of the present disclosure; and

FIG. 7 illustrates an example simplified procedure for vehicle telematics data aggregation and analysis, in accordance with some examples of the present disclosure.

### DETAILED DESCRIPTION

Overview

According to one or more examples of the disclosure, a telematics system receives vehicle state data that indicates directions and speeds of movement of a vehicle over a plurality of time periods. Based on the vehicle state data, the telematics system determines a set of maneuvers performed by the vehicle over the plurality of time periods. In some examples, each maneuver can represent a transition from a first state to a second state in a specific time period. The telematics system also aggregates portions of the vehicle state data for each maneuver of the set of maneuvers to generate maneuver data for each maneuver. The telematics system further determines maneuver characteristics for each maneuver based on the maneuver data, where one or more maneuver characteristics of the maneuver characteristics include motion information. Based on the maneuver characteristics for each maneuver, the telematics system generates a safety score associated with a user of the vehicle. These and other features will be discussed herein with respect to various exemplary embodiments of the disclosed stress monitoring and intervention system.

Description of Example Embodiments

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

A telematics environment can include a communication network, which can include a geographically distributed collection of devices or nodes interconnected by communication links and segments for transporting data there-between. The devices or nodes can include, for example, electronic devices such as personal computers, servers, tablet computers, mobile phones, Internet-of-Things (IoT) devices, smart wearable devices, sensors, and the like. Many types of networks are available, such as local area networks (LANs), wide area networks (WANs), cloud networks, etc. LANs typically connect devices or nodes over dedicated private communications links located in the same general physical location, such as a building or campus. WANs, on the other hand, typically connect geographically dispersed devices or nodes over long-distance communications links, such as common carrier telephone lines, optical lightpaths, synchronous optical networks (SONET), synchronous digital hierarchy (SDH) links, etc.

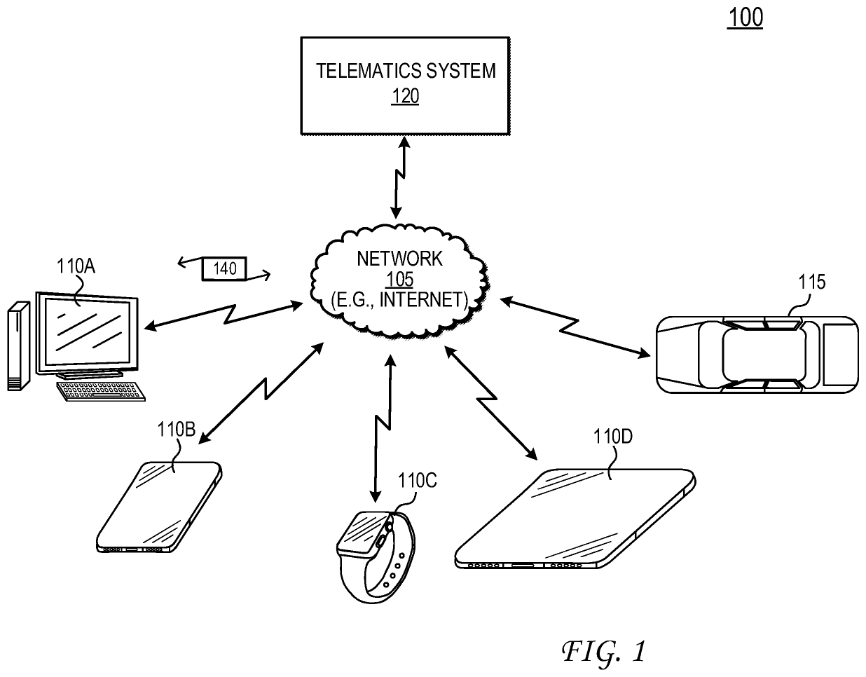

Referring to the figures, FIG. 1 illustrates a schematic diagram of a telematics environment 100, which includes an example communication network 105 (e.g., the Internet). Communication network 105 is shown for purposes of illustration and represents various types of networks, such as local area networks (LANs), wide area networks (WANs), telecommunication networks (e.g., 4G, 5G, etc.), and so on.

As shown, communication network 105 includes a geographically distributed collection of devices or nodes, such as devices 110A, 110B, 110C, and 110D (collectively devices 110), vehicle 115, etc. Devices 110 and vehicle 115 can be interconnected by communication links and/or network segments and exchange or transport data such as data packets 140 to/from a telematics system 120. Devices 110 can include, for example and without limitation, a computer system 110A, a mobile device 110B, a smart wearable device 110C (e.g., a smart watch, smart glasses, etc.), and a tablet device 110D. Vehicle 115 can include, for example, an autonomous vehicle, an electric vehicle, a connected vehicle, a vehicle with one or more electronic devices, etc.

The illustrated devices show example electronic devices, but it is appreciated that devices 110 in the broader sense are not limited to such specific electronic devices. For example, devices 110 can include any number of electronic devices such as laptops, sensors, IoT devices, servers, autonomous systems, navigation systems, cameras, vehicle systems, and so on. In addition, those skilled in the art will understand that any number of devices and links may be used in communication network 105, and that the view shown by FIG. 1 is for simplicity and discussion.

Data packets 140 represent network traffic or messages, which can be exchanged between devices 110, vehicle 115, and telematics system 120 over communication network 105 using one or more network communication protocols such as wired protocols, wireless protocols (e.g., IEEE Std. 802.15.4, WiFi, Bluetooth®, etc.), PLC protocols, and/or other communication and/or shared-media protocols where appropriate. In this context, a protocol can include a set of rules defining how devices or nodes interact with each other.

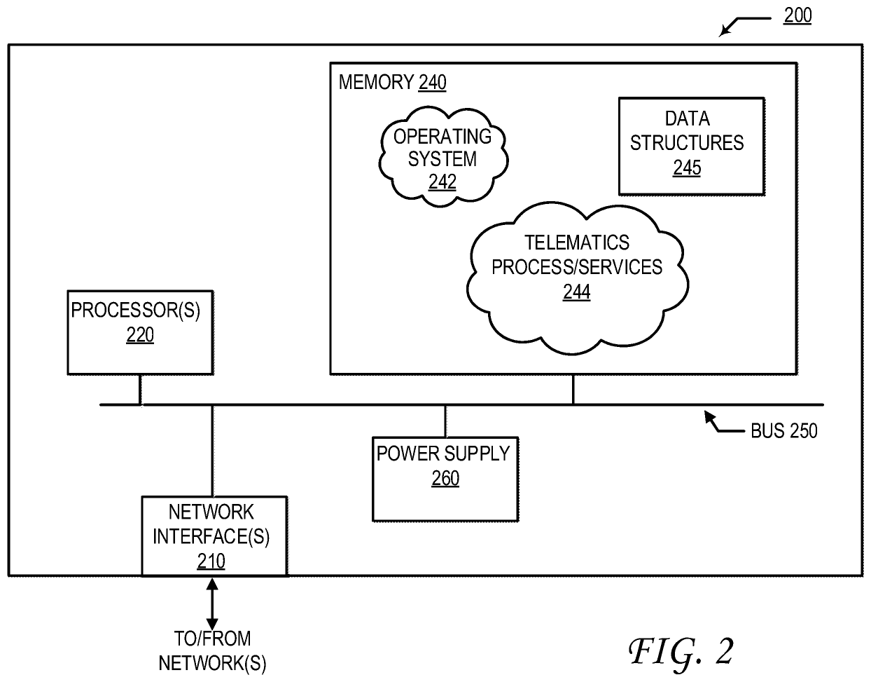

FIG. 2 is a schematic block diagram of an example device 200 that may be used with one or more aspects described herein. For example, device 200 can represent, can be part of, and/or can be implemented by telematics system 120, a component device of telematics system 120, vehicle 115, and/or any of devices 110 shown in FIG. 1. Device 200 can include one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 contain the mechanical, electrical, and signaling circuitry for communicating data over the communication links coupled to communication network 105. Network interfaces 210 may be configured to transmit and/or receive data using a variety of different communication protocols. Network interface 210 is shown for simplicity, and it is appreciated that such interface can represent different types of network connections, e.g., wireless and wired/physical connections. Also, while network interface 210 is shown separately from power supply 260, for PLC the interface may communicate through power supply 260, or may be an integral component of the power supply. In some specific configurations, the PLC signal may be coupled to the power line feeding into the power supply. In addition, it is appreciated that network interfaces 210 can be compatible with the Open Application Program Interface (API) specification to communicate with a variety of new devices, peripherals, etc.

Memory 240 can include storage locations that are addressable by processor 220 and network interfaces 210 for storing software programs and/or data structures associated with the embodiments described herein. Note that certain devices may have limited memory or no memory (e.g., no memory for storage other than for programs/processes operating on the device and associated caches).

Processor 220 can include hardware elements or hardware logic adapted to execute software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include telematics process/services 244, described herein. Note that while telematics process/services 244 is shown in centralized memory 240, alternative embodiments provide for the process to be specifically operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to a model(s) or an organization of interrelated software components/functions. Further, while the telematics process/services 244 is shown as a standalone process, those skilled in the art will appreciate that this process/services may be executed as a routine or module within other processes.

Moreover, while device 200 is shown to include certain components, one of ordinary skill will appreciate that device 200 can include more or fewer components than those shown in FIG. 2. For example, device 200 can also include, in some instances, cache, application specific integrated circuits (ASICs), field-programmable gate arrays (FPGAs), modems, peripheral devices, sensors, and/or other hardware or processing devices that are not shown in FIG. 2.

As noted above, in telematics, data about an object, such as a vehicle or device, can be collected and analyzed to monitor the object, monitor a usage of the object, manage certain aspects of the object, etc. For example, sensors capturing information about the location, movement, state, etc., of a vehicle can be collected and analyzed to track the vehicle, control the vehicle, monitor a usage of the vehicle, and/or determine various characteristics of an operation of the vehicle such as, for example, safety and/or risk characteristics of a user's operation (e.g., driving) of the vehicle. However, the amount of data collected about an object can be increasingly large and difficult to analyze. Moreover, the difficulty of processing the collected data and making accurate and intelligent calculations based on the collected data can increase as the amount and complexity of data collected grows. In many telematics applications, it is significantly difficult to filter or scale the collected data in an accurate and/or intelligent manner. It is also significantly difficult to categorize, aggregate, and interpret collected data in an accurate and/or intelligent manner.

For example, in the vehicle telematics context, the amount of telematics data collected for a vehicle can be significantly large and difficult to understand. In some cases, the telematics data can include a vast amount of sub-second-level of data measurements (and/or other levels of data measurements) related to the operation of the vehicle. The amount of telematics data collected for the vehicle can quickly grow large and difficult to understand, model, characterize, and/or correlate to different vehicle (and/or driver) operations, behaviors, risks, etc. In many cases, it can be very difficult to aggregate, identify, and/or categorize relevant and/or related features represented in the telematics data in order to better understand, manage, and/or correlate aspects of the vehicle's behavior or the driver's operation of the vehicle.

Accordingly, the techniques described herein can provide accurate and efficient processes to monitor, classify and/or quantify the operation and/or usage of a vehicle. In some examples, telematics data for a vehicle can be used to identify and/or classify different vehicle maneuvers. Portions of telematics data can be aggregated by corresponding maneuvers to better understand and/or model an overall behavior and/or operation of the vehicle. For example, the aggregated data corresponding to each vehicle maneuver can be analyzed to understand each vehicle maneuver. The vehicle maneuvers (and/or associated data) can be used to understand and/or model an overall operation of the vehicle (and/or a driver of the vehicle). This information can be used for a variety of applications and processes such as, for example, vehicle tracking, vehicle navigation, vehicle safety and/or risk management, usage-based automotive insurance calculations, among others. While the techniques discussed herein focus, in part, on understanding and/or quantifying vehicle operations/usage, the techniques in the broader sense can be implemented in a variety of other telematics applications and calculations, as noted above.

In some examples, these processes can be embodied and/or implemented by a telematics platform, which can include various systems, devices, and methods discussed herein. At a high level, the platform can employ telematics techniques to provide technical solutions for processing, monitoring and analyzing telematics data, and understanding and/or quantifying various aspects of an operation of a device or vehicle, such as a usage of a vehicle. For example, the processes can be used to understand, model, and/or quantify a usage of a vehicle over time.

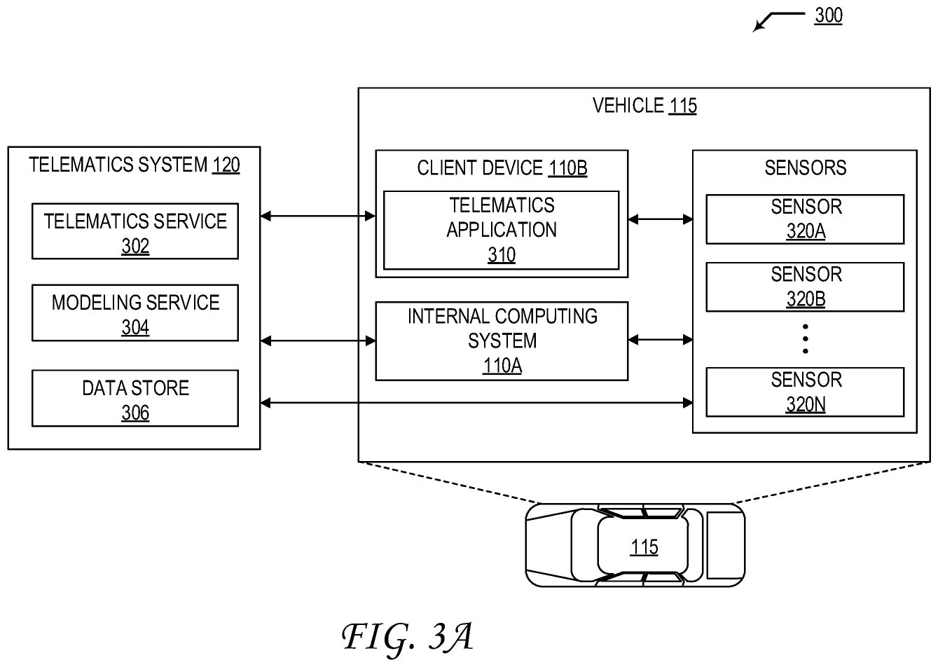

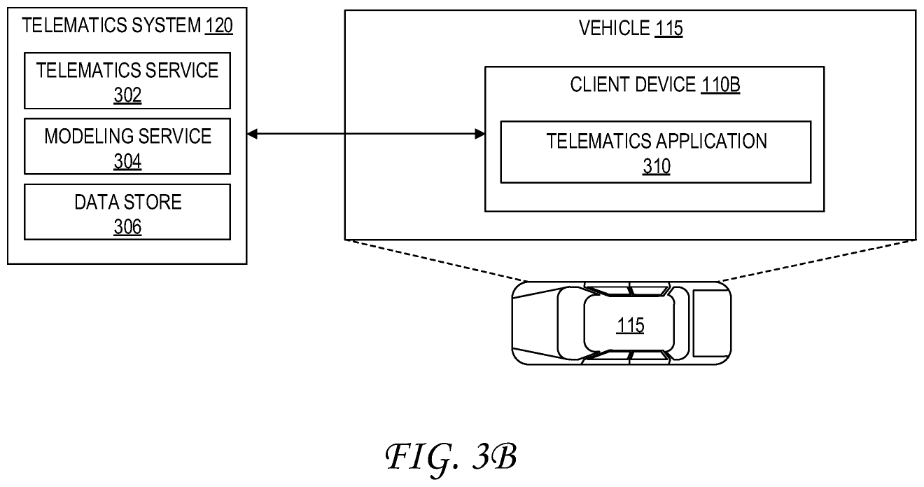

FIG. 3A illustrates a schematic block diagram 300 of telematics system 120 and vehicle 115. Telematics system 120 can collect vehicle state data (e.g., telematics data) measuring various states and/or operations of vehicle 115, to process, analyze, aggregate, etc., the vehicle state data and classify, model, and/or quantify a usage of vehicle 115. For example, in some cases, telematics system 120 can collect vehicle state data measuring various states and/or operations of vehicle 115. Telematics system 120 can use the vehicle state data to identify various maneuvers performed by vehicle 115 over time and classify, model, and/or quantify a usage risk (or safety) of vehicle 115 (and/or a driver associated with vehicle 115). Telematics system 120 can aggregate portions of vehicle state data corresponding to each maneuver into maneuver data for each maneuver (also referred to as “maneuver-level data segments”), and determine maneuver characteristics for each maneuver (also referred to as “maneuver-level features”) based on the maneuver data for each maneuver. In some examples, the maneuver characteristics can include labels, classification identifiers, tags, maneuver statistics (and/or vehicle activity statistics), context information, maneuver (and/or vehicle activity) descriptors and/or details, scores, etc. Telematics system 120 can use these maneuver characteristics (in addition to or in lieu of) the maneuver data (and/or corresponding maneuvers) to perform a risk analysis and/or calculation associated with an operation and/or usage of the vehicle.

Telematics system 120 can include a telematics service 302, a modeling service 304, and a data store 306. In some examples, telematics service 302 can collect vehicle state data (e.g., telematics data) measuring and/or describing an operation, state, and/or context of vehicle 115, process the collected data, identify features in the collected data (e.g., maneuvers, operations, statistics, descriptors, scores, etc.), aggregate and/or correlate related and/or relevant portions of the collected data, aggregate maneuver characteristics (e.g., maneuver-level features) for each identified maneuver, enhance the data associated with maneuvers (e.g., label, tag, classify, supplement, etc.), and/or use the collected data to perform other calculations/operations.

Modeling service 304 can model and/or quantify the data collected and/or processed by telematics service 302. For example, modeling service 304 can model behaviors and/or operations represented by, and/or identified in, the data from telematics service 302. In some cases, modeling service 304 can generate a usage model to quantify a risk level associated with an operation or use of vehicle 115. For example, modeling service 304 can generate a usage model and/or calculate a risk or safety score for an overall use of vehicle 115. The risk or safety score can be used at least in part to, for example and without limitation, perform a vehicle and/or driver risk/safety assessment, manage operations of the vehicle, calculate a usage-based insurance cost for a user associated with the vehicle, among other things.

Data store 306 can store data (e.g., collected data, calculations, parameters, models, metadata, outputs, statistics, measurements, etc.) from telematics service 302 and/or modeling service 304. In some examples, data store 306 can store data from other components, systems or devices, such as external systems or devices (e.g., external to telematics system 120), one or more networks, etc. For example, data store 306 can store context data (e.g., weather information, traffic information, vehicle information, driver information, geographic information, environmental information, statistics, usage conditions data, etc.) and/or other data associated with vehicle 115, one or more devices on/in vehicle 115, external data sources (e.g., the Internet, a weather service, a traffic service, a vehicle manufacturer/vendor, a mapping service, a navigation service, a government agency, etc.), among other sources.

In one illustrative example, data store 306 can store vehicle state data collected by telematics service 302 in certain time intervals (e.g., sub-second intervals, second intervals, and/or any other intervals). The vehicle state data can include, for example and without limitation, motion information and timestamps associated with the motion information. The motion information can include, for example and without limitation, velocity measurements, distance measurements, speed measurements, time measurements, heading/direction information, trajectory information, position information, acceleration data, and/or any other motion information and/or associated timestamps. Acceleration data can include acceleration/deceleration in speed and/or direction. Moreover, in some examples, acceleration data can include acceleration/deceleration amounts, speed or velocity, direction/heading, a degree of a change(s) of direction/heading, associated distance information, a ratio of motion values over time, etc. In some examples, acceleration data can also include timestamps associated with portions (e.g., measurements) of the acceleration data. Telematics system 120 can analyze (e.g., via telematics service 302 and/or modeling service 304) measurements in the vehicle state data (e.g., speed, heading, distance, acceleration/deceleration amounts, etc.) and associated timestamps, changes in acceleration/deceleration (e.g., speed, heading, etc.) over certain time intervals (e.g., sub-seconds, seconds, minutes, etc.) and/or distances (e.g., miles, yards, meters, etc.). Acceleration/deceleration changes can be from a moving state or a stopped (non-moving) state. Telematics system 120 can use the vehicle state data to identify (e.g., via telematics service 302 and/or modeling service 304) maneuvers, generate maneuver-level data segments corresponding to the identified maneuvers and generate maneuver-level features associated with the maneuver-level data segments.

Telematics system 120 can identify, classify and/or score various aspects of each maneuver (and/or groups of maneuvers) such as, for example, the beginning and/or end of a maneuver; whether a steady speed and/or direction (e.g., the same speed and/or direction, a threshold range of speed and/or direction) was established before, during, and/or after the maneuver; a safety and/or risk score for the maneuver; a type of maneuver; a description of the maneuver; statistical features; etc. Non-limiting examples of a maneuver can include turning, changing lanes, exiting a road, entering a road, stopping at a traffic sign (e.g., a stop light, a stop sign, a train signal, etc.), braking, crashing, a u-turn, speeding, transitioning to a different state, etc. In some cases, telematics system 120 can label driving data for each trip with information identifying associated maneuvers, maneuver features (e.g., statistics, descriptors, etc.), steady states, and/or other information.

In some examples, telematics system 120 can aggregate maneuver-level features associated with each maneuver-level data segment determined for identified maneuvers such as, for example, speed, direction, acceleration/deceleration amount, maneuver type, maneuver duration, maneuver distance, maneuver start/end, maximum speed, minimum speed, starting state, end state, maneuver risk score, etc. Telematics system 120 can use the maneuver-level features to build a telematics risk model for the vehicle (and/or a user associated with the vehicle). In some cases, the telematics risk model can quantify a driving risk/safety based on, for example, a percent or amount of acceleration/deceleration maneuvers within a range or threshold (e.g., a range or threshold speed and/or direction change over time and/or distance), an amount or percentage of certain types of maneuvers, a ratio of certain states (e.g., turns, acceleration/deceleration, etc.) over other states, etc.

As shown in FIG. 3A, telematics service 302 can obtain the vehicle state data associated with vehicle 115 from internal computing system 110A, client device 110B, and/or any of sensors 320A through 320N (collectively sensors 320). In some examples, sensors 320 can send vehicle state data to telematics system 120 over a network (e.g., network 105) or provide the vehicle state data to internal computing system 110A and/or client device 110B, which can send the vehicle state data to telematics system 120.

Internal computing system 110A can represent one or more computers included in, and/or implemented by, vehicle 115. For example, internal computing system 110A can represent a computing system in vehicle 115 that controls one or more operations and/or functions of vehicle 115. Client device 110B can represent an electronic device associated with a driver of vehicle 115 (or a user in vehicle 115), such as a mobile phone, a laptop, a tablet, a smart wearable device, a camera, etc.

Client device 110B can include a telematics application 310 that collects vehicle state data and sends the vehicle state data to telematics system 120. Telematics application 310 can obtain the vehicle state data from one or more sensors on client device 110B, sensors 320, and/or internal computing system 110A (e.g., which can obtain the vehicle state data from sensors 320). In some examples, telematics application 310 can obtain the vehicle state data from one or more of sensors 320A through 320N. In some cases, internal computing system 110A can also implement telematics application 310 to collect vehicle state data and provide the vehicle state data to telematics system 120.

Sensors 320 can be part of, or implemented by, vehicle 115, internal computing system 110A, and/or client device 110B. Sensors 320 can include any sensor device or system for detecting and/or measuring information such as objects, proximity, motion information (e.g., speed, direction, acceleration/deceleration, etc.), position information, light, sound, environment conditions, etc. Non-limiting examples of sensors include image sensors (e.g., still image camera sensors or devices, video camera sensors or devices, etc.), light detection and ranging (LIDAR) sensors, gyroscopes, accelerometers, magnetometers, radars, inertial measurement units (IMUs), temperature sensors, humidity sensors, sound sensors, light sensors, machine vision sensors, among others.

In some cases, vehicle 115 may not implement internal computing system 110A or any of the sensors 320. In such cases, telematics system 120 may obtain the vehicle state data associated with vehicle 115 from client device 110B (e.g., via telematics application 310). For example, with reference to FIG. 3B which shows vehicle 115 without internal computing system 110A or sensors 320, telematics system 120 can obtain vehicle state data captured by one or more sensors implemented by client device 110B, without alternatively or additionally obtaining vehicle state data captured by one or more sensors implemented by vehicle 115.

Client device 110B can use one or more sensors to capture vehicle state data during an operation of vehicle 115. For example, client device 110B can use one or more sensors on client device 110B to capture vehicle state data while the client device 110B is in vehicle 115. Telematics application 310 can collect the vehicle state data obtained by client device 110B and send the vehicle state data to telematics system 120.

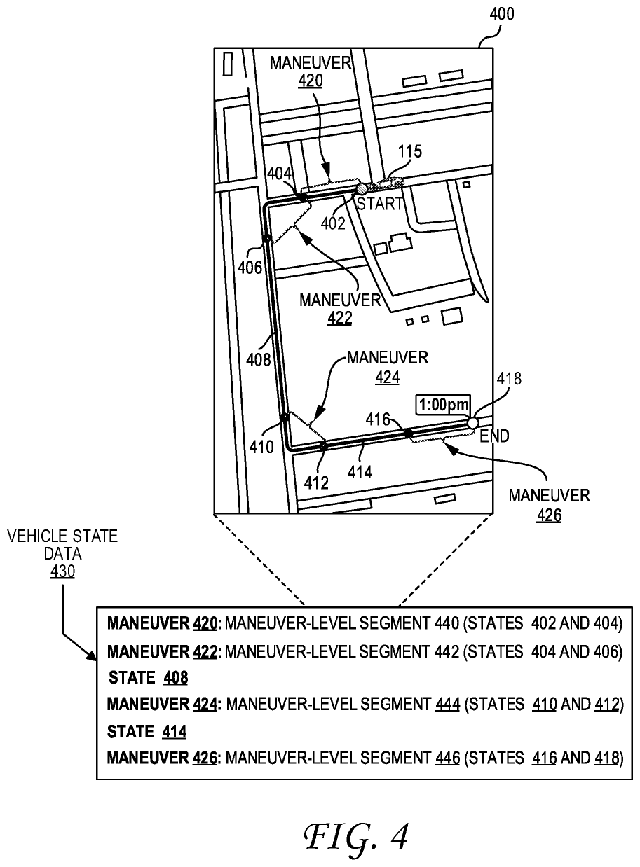

FIG. 4 illustrates a schematic block diagram showing example maneuver-level data segments generated from streams of telematics data collected for vehicle 115 during a trip 400 from a starting point 402 to an ending point 418. Here, vehicle 115 begins at point 402 with an acceleration maneuver 420 to state 404, where vehicle 115 transitions to a different maneuver 422 from state 404 to state 406. State 404 can represent the start of a maneuver 422 performed by vehicle 115. Maneuver 422 can begin at state 404 and continue for a certain amount of time and/or distance until state 406. In this example, maneuver 422 represents a left turn performed by vehicle 115. In some cases, maneuver 422 can include the left turn as well as a deceleration of vehicle 115 for a certain amount of time and distance as vehicle 115 approaches the left turn (e.g., a deceleration from state 404) and/or an acceleration of vehicle 115 for certain amount of time and distance after vehicle 115 completes the left turn (e.g., an acceleration after the left turn until state 406). State 406 represents the beginning of a steady state operation of vehicle 115 or a completion of maneuver 422 prior to beginning a steady state operation.

From state 406, vehicle 115 travels at a state 408 until transitioning to state 410. In some examples, state 408 can represent a steady travel state. Vehicle 115 travels at a steady state when vehicle 115 remains within a threshold range of speeds and/or directions (and/or without a threshold change in speed and/or direction) for a certain distance and/or amount of time. State 410 can represent a beginning of another maneuver 424 and state 412 represents the end of maneuver 424. In this example, maneuver 424 represents a left turn by vehicle 115. In some cases, maneuver 424 can include the left turn as well as a deceleration of vehicle 115 for a certain amount of time and distance, as vehicle 115 approaches the left turn and/or an acceleration of vehicle 115 for certain amount of time and distance after vehicle 115 completes the left turn. In some cases, maneuver 424 can continue until vehicle 115 transitions to state 412. After transitioning to state 410, vehicle 115 can continue traveling at state 414 until transitioning to a deceleration maneuver 426 at state 416. Deceleration maneuver 426 can begin at state 416 and end at point 418.

Telematics system 120 can collect vehicle state data 430 captured by one or more sensors (e.g., one or more of sensors 320) during trip 400, including any of states 402 through 418 and/or any of maneuvers 420 through 426. For example, telematics system 120 can collect vehicle state data 430 captured during maneuver 420, maneuver 422, state 408, maneuver 424, state 414 and/or maneuver 426. In some examples, telematics application 310, which can run on internal computing system 110A and/or client device 110B, can obtain vehicle state data 430 from one or more sensors and send vehicle state data 430 to telematics system 120. Vehicle state data 430 can include measurements captured during trip 400 and associated timestamps. For example, vehicle state data 430 can include motion data measured at various intervals during trip 400, such as intervals from state 402 to state 404 (and/or during maneuver 420), from state 404 to state 406 (and/or during maneuver 422), from state 410 to state 412 (and/or during maneuver 424), and from state 416 to state 418 (and/or during maneuver 426). The motion data included in vehicle state data 430 can measure speed, direction, distance, time, velocity, and/or any changes in speed and/or direction.

In some examples, the motion information included in vehicle state data 430 can include, for example, a duration of a state, maneuver, and/or transition from one state to another; a distance traveled during a state, maneuver, and/or a transition from one state to another; a maximum and/or minimum speed traveled by vehicle 115 during a state, maneuver, and/or from one state to another (and/or any speed there-between); a starting direction and/or ending direction associated with a state, maneuver, and/or a transition from one state to another (and/or any direction there-between); timestamps associated with each measurement; a maximum and/or minimum speed traveled during trip 400; an acceleration/deceleration amount at one or more intervals, states, and/or maneuvers; a duration of trip 400; etc. Vehicle state data 430 can include timestamps identifying the times and/or intervals when each portion of vehicle state data (e.g., each measurement) was captured.

Telematics system 120 can analyze vehicle state data 430 and determine that vehicle 115 performed maneuvers 420, 422, 424, and 426 during trip 400. Telematics system 120 can identify maneuvers 420, 422, 424 and 426 based on one or more factors such as, for example and without limitation, acceleration/deceleration changes (e.g., in speed and/or direction) within a threshold and/or range (e.g., a degree of acceleration/deceleration), a distance traveled during the acceleration/deceleration changes, an amount of time traveled during the acceleration/deceleration changes, a failure to remain within a threshold and/or range of speed and/or direction for a certain duration and/or distance, etc.

In some cases, the one or more factors (and/or any associated thresholds/ranges) can vary based on a context such as, for example, a type of road (e.g., a city street, a highway, a residential area, etc.), one or more characteristics of a road (e.g., a number of lanes, road conditions, an amount and/or degree of turns and/or curves, an amount of traffic, a number of pedestrians, a speed limit, etc.), environmental conditions (e.g., weather, visibility, etc.), a type of vehicle (e.g., all-wheel drive, front-wheel drive, rear wheel drive, compact vehicle, large vehicle, sports vehicle, etc.), relevant regulations (e.g., speed limits, etc.), relevant traffic signals/signs, and/or any conditions that may impact a driving risk and/or difficulty associated with an area traveled (e.g., road, etc.). For example, a threshold and/or range of acceleration/deceleration used to classify an operation of a vehicle (e.g., one or more states of a vehicle) as a maneuver can change (e.g., can increase or decrease) depending on the context. To illustrate, the threshold and/or range of acceleration/deceleration used to classify a maneuver when traveling on a road with a speed limit of 15 miles per hour (mph) can be lower than the threshold and/or range used to classify the maneuver when traveling on a road with a speed limit of 65 mph.

When analyzing vehicle state data 430, telematics system 120 can aggregate different portions of vehicle state data 430 correlated to a specific maneuver to generate maneuver-level data segments 440, 442, 444, and 446. For example, if vehicle state data 430 includes vehicle state data corresponding to maneuver 420, telematics system 120 can aggregate the portions of vehicle state data 430 corresponding to maneuver 420 to generate maneuver-level data segment 440. In this example, maneuver-level data segment 440 includes vehicle state data associated with state 402 and state 404. If vehicle state data 430 includes vehicle state data corresponding to maneuver 422, telematics system 120 can aggregate the portions of vehicle state data 430 corresponding to maneuver 422 to generate maneuver-level data segment 442. In this example, maneuver-level data segment 442 includes vehicle state data associated with state 404 and state 406.

Similarly, if vehicle state data 430 includes vehicle state data corresponding to maneuver 424, telematics system 120 can aggregate the portions of vehicle state data 430 corresponding to maneuver 424 to generate maneuver-level data segment 444. In this example, maneuver-level data segment 442 includes vehicle state data associated with state 410 and state 412. If vehicle state data 430 includes vehicle state data corresponding to maneuver 426, telematics system 120 can aggregate the portions of vehicle state data 430 corresponding to maneuver 426 to generate maneuver-level data segment 446. In this example, maneuver-level data segment 446 includes vehicle state data associated with state 416 and state 418.

The maneuver-level data segments 440, 442, 444, and 446 (e.g., the aggregated vehicle state data associated with maneuvers 420, 422, 424 and 426) can respectively represent and/or identify maneuvers 420, 422, 424, and 426. Telematics system 120 can identify maneuvers 420, 422, 424, and 426 based on vehicle state data 430 and divide vehicle state data 430 into maneuver-level data segments 440, 442, 444, and 446 corresponding to 420, 422, 424, and 426, respectively. In some examples, telematics system 120 can store, organize, analyze, and/or otherwise process data aggregated by maneuver.

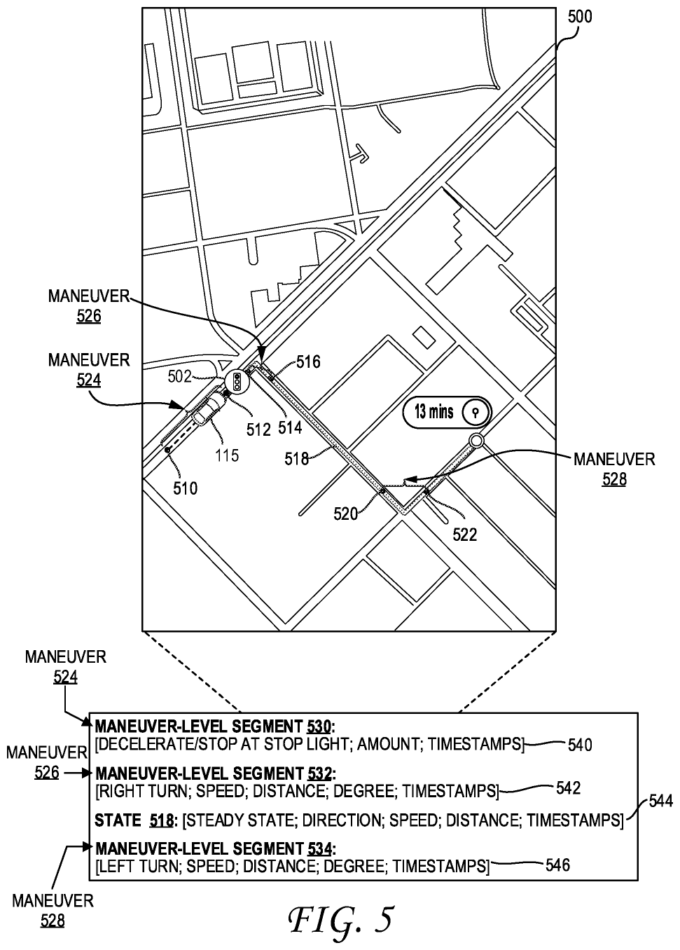

FIG. 5 illustrates a schematic block diagram showing maneuver-level features 540, 542, 546 identified for maneuver-level data segments 530, 532, 534 determined for a trip 500. In this example, maneuver 524 includes a deceleration from state 510 to state 512 to stop at a stop light 502, maneuver 526 is a right turn from state 514 to state 516, and maneuver 528 is a left turn from state 520 to state 522. In some examples, maneuver 526 can include the right turn as well as an acceleration period/distance after stopping at stop light 502, a deceleration period/distance as vehicle 115 approaches the right turn, and/or an acceleration period/distance after vehicle 115 completes the right turn (e.g., until state 516). Moreover, in some examples, maneuver 528 can include the left turn as well as a deceleration period/distance as vehicle 115 approaches the left turn (e.g., a deceleration from state 520 to the left turn) and/or an acceleration period/distance after vehicle 115 completes the left turn (e.g., until state 522). Telematics system 120 can identify maneuvers 524, 526, and 528 from vehicle state data collected at various intervals during the maneuvers, as previously described.

Telematics system 120 can aggregate portions of vehicle state data collected for/during trip 500. In some examples, telematics system 120 can aggregate the portions of vehicle state data by maneuver to generate maneuver-level data segments 530, 532, 534, as previously described. For example, telematics system 120 can aggregate portions of vehicle state data corresponding to maneuver 524 to generate maneuver-level data segment 530 associated with maneuver 524. Telematics system 120 can similarly aggregate portions of vehicle state data corresponding to maneuver 526 to generate maneuver-level data segment 532, and aggregate portions of vehicle state data corresponding to maneuver 528 to generate maneuver-level data segment 534. In some examples, telematics system 120 can label aggregated vehicle state data by maneuver, maneuver identifier, etc. For example, telematics system 120 can label maneuver-level data segments 530, 532, 534 by respective maneuver, maneuver identifier, etc. In some cases, telematics system 120 can optionally maintain and/or aggregate portions of vehicle state data corresponding to a state that does not include and/or correspond to a maneuver, such as state 518.

Telematics system 120 can determine one or more maneuver-level features for a maneuver (and/or the maneuver-level data segment corresponding to the maneuver). In some examples, telematics system 120 can determine the one or more maneuver-level features for a maneuver based on vehicle state data associated with the maneuver. For example, telematics system 120 can identify one or more measurements in maneuver-level data segment 530 associated with maneuver 524 and use the one or more measurements (e.g., raw measurements, labeled measurements, summarized and/or interpreted measurements, classified measurements, and/or otherwise processed measurements) to determine maneuver-level features for maneuver 524. In some cases, telematics system 120 can use one or more measurements in a maneuver-level data segment of a maneuver to classify the maneuver (and/or one or more aspects of the maneuver), recognize one or more characteristics of the maneuver, and/or quantify one or more aspects of the maneuver. For example, telematics system 120 can use a neural network or any statistical or machine learning model to analyze data in the maneuver-level data segment of a maneuver and classify the maneuver and/or one or more aspects of the maneuver. Telematics system 120 can include such determined information (e.g., classification, characteristics, quantifying information, etc.) as maneuver-level features of the maneuver.

In some cases, telematics system 120 can aggregate maneuver-level features associated with a maneuver. For example, telematics system 120 can aggregate maneuver-level features associated with maneuver 524 (e.g., associated with maneuver-level data segment 530) to generate maneuver-level features 540. Telematics system 120 can aggregate maneuver-level features associated with maneuver 526 (e.g., associated with maneuver-level data segment 532) to generate maneuver-level features 542, and maneuver-level features associated with maneuver 528 (e.g., associated with maneuver-level data segment 534) to generate maneuver-level features 546.

In some examples, telematics system 120 can associate (e.g., map, tag, add, assign, include, append, etc.) one or more maneuver-level features with a maneuver and/or maneuver-level data segment. For example, telematics system 120 can add or append maneuver-level features 540, 542, and 546 respectively to maneuver-level data segments 530, 532, and 534. In some cases, telematics system 120 can also add one or more maneuver-level features to data corresponding to a state that does not include and/or represent a maneuver determined as previously described. For example, telematics system 120 can add maneuver-level feature 544 to state 518.

Maneuver-level features can include information about maneuvers, such as one or more characteristics of the associated maneuvers, maneuver identifiers and/or labels, details and/or descriptions of the associated maneuvers and/or one or more aspects of the associated maneuvers, timestamps associated with the maneuvers (and/or associated data and/or operations), vehicle state measurements, context information, scores determined for maneuvers (and/or aspects of the maneuvers), and/or any other information. For example, maneuver-level features can include information identifying a type of maneuver, one or more acceleration/deceleration amounts during the maneuver, one or more directions and/or speeds during the maneuver, a distance traveled during the maneuver, a duration of the maneuver, a maximum and/or minimum acceleration/deceleration during the maneuver, a starting speed and/or direction, an ending speed and/or acceleration, and/or any other motion information and/or statistics.

To illustrate, in the example shown in FIG. 5, maneuver-level features 540 associated with maneuver 524 and maneuver-level data segment 530 include information indicating that maneuver 524 involved decelerating and stopping at a stop light as well as a deceleration amount (e.g., change of speed over a certain distance and/or time). Maneuver-level features 542 indicate that maneuver 526 involved a right turn and indicate a speed, distance, and degree of turn during maneuver 526. Maneuver-level features 544 indicate that state 518 involved a steady state at a certain direction and speed (and/or range of directions and/or speeds) over a certain distance. Maneuver-level features 546 indicate that maneuver 528 involved a left turn and indicate a speed, distance, and degree of turn during maneuver 528.

In some examples, telematics system 120 can use maneuver-level data segments 530, 532, and 534 and/or maneuver-level features 540, 542, and 546 to quantify an operation of vehicle 115 and/or a driving behavior during trip 500, as further described herein. For example, telematics system 120 can use maneuver-level features 540, 542, and 546 (and optionally maneuver-level data segments 530, 532, and/or 534) to build a telematics risk model and/or calculate a risk score associated with the operation of vehicle 115 and/or the driving behavior. In some cases, telematics system 120 can analyze maneuvers, maneuver-level data segments and/or maneuver-level features determined for multiple trips of vehicle 115 (and/or an associated user) to build the telematics risk model and/or calculate the risk score. In some cases, telematics system 120 can consider other information associated with the trip(s), such as context information, information from external sources, other statistics, etc.

In some cases, telematics system 120 can use a neural network or any statistical or machine learning model to categorize maneuvers and quantify aspects of the maneuvers based on vehicle state data associated with the maneuvers. For example, telematics system 120 can analyze a maneuver-level data segment and/or a maneuver-level feature(s) associated with a maneuver and categorize the maneuver as a lane change. To illustrate, assume the lane change begins with a moderately small change in direction (e.g., right or left), followed by a corresponding change in direction of similar size in the opposite direction (e.g., with little to no difference between the direction at the beginning of the lane change and the direction at the end of the lane change). Once the maneuver has been classified as a lane change, telematics system 120 can quantify the “hardness” of the maneuver (the lane change) by the degrees and duration (e.g., by degrees over time) of the two changes in direction. Telematics system 120 can calculate a score indicating a more aggressive lane change when the ratio of degrees over time is higher, and a score indicating a less aggressive lane change when the ratio of degrees over time is lower. The more aggressive lane change can indicate and/or represent a more dangerous/risky maneuver than the less aggressive lane change.

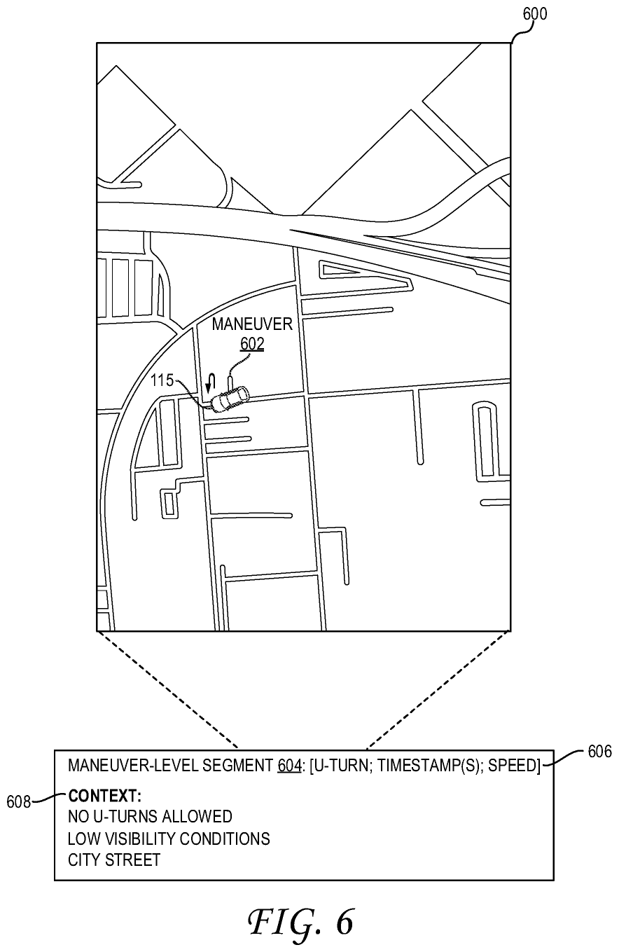

FIG. 6 illustrates a schematic block diagram showing a maneuver 602 identified for a trip 600 and a context 608 associated with the maneuver 602. In this example, maneuver 602 represents a u-turn performed by vehicle 115. Maneuver 602 is associated with maneuver-level data segment 604. Maneuver-level data segment 604 is associated with maneuver-level features 606 determined for maneuver 602. As shown, maneuver 602 is associated with context 608, which can be optionally determined for maneuver 602. Context 608 can be included in maneuver-level data segment 604, maneuver-level features 606 and/or separately associated with maneuver 602, maneuver-level data segment 604 and/or maneuver-level features 606.

Context 608 can include information about the circumstances associated with maneuver 602 and vehicle 115. For example, context 608 can include information associated driving rules (e.g., no u-turns allowed at the location where maneuver 602 was executed, speed limit, etc.), conditions during maneuver 602 (e.g., visibility conditions, road conditions, weather, traffic, etc.), the location where maneuver 602 was executed (e.g., city street, highway, residential area, proximity to a school, amount and/or degree of curves or turns, etc.), events at or near the location of maneuver 602 (e.g., accident, road work, protest, concert, crossing animal or human, obstacle on the road, maneuvers of one or more surrounding vehicles, etc.), characteristics of vehicle 115 (e.g., small vehicle, large vehicle, sports vehicle, motorcycle, all-wheel drive, front-wheel drive, rear-wheel drive, etc.), estimated reason for maneuver 602 (e.g., to avoid a risk or danger, to respond to an action by another vehicle, etc.), and/or any other context information.

Telematics system 120 can determine some or all of the information associated with context 608 from vehicle state data associated with vehicle 115, maneuver 602, and/or trip 600. In some cases, telematics system 120 can determine some or all of the information associated with context 608 from one or more other sources. For example, telematics system 120 can collect information pertaining to a time of maneuver 602 and/or trip 600 from the Internet, a weather service, a traffic service, a mapping and/or navigation service, a government agency, a nearby camera, a camera on vehicle 115, a remote server, a news service, etc.

In some examples, telematics system 120 can use context 608 to analyze, identify, quantify, and/or understand one or more aspects of maneuver 602. For example, telematics system 120 can use context 608 along with maneuver-level features 606 (and/or maneuver-level data segment 604) to calculate a score for maneuver 602. The score can indicate a level of risk or danger of maneuver 602, an aggressiveness of maneuver 602, etc. In some cases, telematics system 120 can use scores and/or associated maneuvers calculated for vehicle 115 to build a telematics risk model and/or generate an overall risk score associated with an operation of vehicle 115 (and/or a user associated with vehicle 115) over time. Telematics system 120 can also use the telematics risk model and/or overall risk score to perform other calculations and/or implement usage-based measures. For example, telematics system 120 can use an overall risk score calculated for an operation of vehicle 115 over time to calculate and/or adjust a usage-based insurance cost for a user associated with vehicle 115. To illustrate, in some cases, the overall risk score can be used to reduce or increase the cost of a user's automotive insurance associated with vehicle 115. The automotive insurance can be lower when the overall score indicates a lower driving risk and higher when the overall score indicates a higher driving risk.

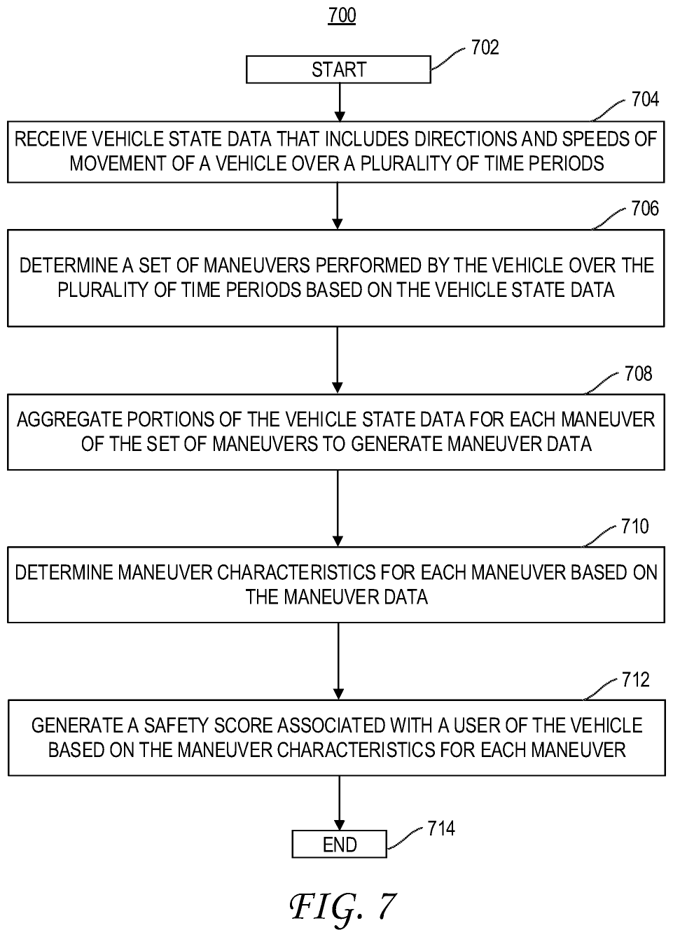

FIG. 7 illustrates an example simplified procedure 700 for vehicle telematics data aggregation and analysis, in accordance with the processes described above. For purposes of discussion, the operations for procedure 700 are described in the context of telematics system 120 or simply the “system.”

Procedure 700 begins at step 702 and continues to step 704, where the system receives vehicle state data (e.g., vehicle state data 430) that includes directions and speeds of movement of a vehicle (e.g., vehicle 115) over a plurality of time periods. The system can receive the vehicle state data from one or more devices. The one or more devices can include sensors (e.g., sensors 320) for capturing sensor data such as measurements, image data (e.g., still images, video frames, etc.), sound, light, etc.

In some examples, the vehicle state data can include an amount of acceleration of the vehicle, an amount of deceleration of the vehicle, an amount of change in direction of the vehicle, one or more speeds of the vehicle, one or more directions of the vehicle, one or more types of actions performed by the vehicle, etc. In some cases, the vehicle state data can also include a timestamp(s), an amount of time and an amount of distance associated with the amount of acceleration of the vehicle, the amount of deceleration of the vehicle, the amount of change in direction of the vehicle, the one or more speeds of the vehicle, the one or more directions of the vehicle, the one or more types of actions performed by the vehicle, etc.

Procedure continues to step 706, where the system determines, based on the vehicle state data, a set of maneuvers (e.g., maneuvers 524, 526, 528) performed by the vehicle over the plurality of time periods. In some examples, each maneuver can represent a transition from a first state (e.g., state 510) to a second state (e.g., state 512). In some cases, the first state can represent and/or include the beginning of the maneuver and the second state can represent and/or include the end of the maneuver. In some examples, the beginning and end of a maneuver (e.g., the first state and the second state) can be determined based on a respective threshold acceleration/deceleration, such as a change in speed in a given amount of time, and/or a respective threshold change in direction. For example, the vehicle can travel at a steady state (e.g., state 518), which can have some variations in speed and/or distance. The vehicle can then transition to the first state (e.g., state 520). The first state can mark the beginning of a maneuver (e.g., maneuver 528) when there is a deceleration (e.g., a negative change in speed over time) that exceeds a threshold deceleration (e.g., as the vehicle approaches the turn in example maneuver 528). The second state can mark the end of the maneuver (e.g., maneuver 528) when the acceleration (e.g., a positive change in speed over time) decreases to below a certain threshold that signals a transition from acceleration (e.g., following the turn in example maneuver 528) to steady state driving. As another example, a change in direction (e.g., a heading acceleration) can trigger the beginning of a maneuver even if the vehicle does not change in speed (e.g., accelerate or decelerate) sufficiently to trigger a maneuver threshold based on speed acceleration/deceleration.

In some cases, an acceleration/deceleration threshold and/or a change in direction threshold can trigger the beginning and/or end of a maneuver. In other cases, an acceleration/deceleration threshold and/or a change in direction threshold can trigger the beginning of a maneuver, but an end of the maneuver is triggered by both an acceleration/deceleration threshold and a change in direction threshold. For example, once a maneuver (e.g., maneuver 528) is triggered as beginning at a first state (e.g., state 520) based on a deceleration/acceleration and/or change in heading, the end of the maneuver (e.g., the second state) may not be identified or triggered until the vehicle has both reached a steady speed and a steady direction.

In some examples, each maneuver can represent a transition from a first state (e.g., state 510) to a second state (e.g., state 512) in a specific time period. In other examples, each maneuver can represent a transition from a first state (e.g., state 518) to a second state (e.g., state 520) and a transition from the second state to a third state (e.g., state 522). In some examples, the specific time period can be equal to or greater than a threshold amount of time (and/or range of times) defined as a timing condition for categorizing one or more vehicle activities as a maneuver.

In some examples, to determine the set of maneuvers, the system can determine (e.g., based on the vehicle state data) that the vehicle traveled for a threshold period of time and/or a threshold distance during the transition from the first state to the second state, determine that the transition from the first state to the second state satisfies a condition for classifying vehicle activities as maneuvers, and classify the transition from the first state to the second state as the maneuver. The system can do this for each maneuver identified. In some examples, the condition can include the threshold distance and/or the threshold period of time.

For example, the system can define the threshold distance and/or the threshold period of time as a condition(s) or trigger(s) for classifying vehicle activity as a maneuver. The system can determine the specific time period associated with the transition from the first state to the second state and a specific distance traveled during the transition, and determine that the specific time period satisfies the threshold period of time (e.g., is equal to or greater than the threshold period of time) and/or the specific distance satisfies the threshold distance (e.g., is equal to or greater than). The system can then determine that the specific time period and/or distance satisfies or satisfy the condition(s) or trigger(s) and thus that the transition is a maneuver.

In some examples, each vehicle state (e.g., the first state and the second state) can include an amount of acceleration of the vehicle, an amount of deceleration of the vehicle, an amount of change in direction of the vehicle, one or more speeds of the vehicle during a respective maneuver, one or more directions of the vehicle during the respective maneuver, one or more types of actions performed by the vehicle during the respective maneuver, etc. In some cases, each vehicle state can also include a timestamp(s), an amount of time and an amount of distance associated with the amount of acceleration of the vehicle, the amount of deceleration of the vehicle, the amount of change in direction of the vehicle, the one or more speeds of the vehicle during the respective maneuver, the one or more directions of the vehicle during the respective maneuver, and/or the one or more types of actions performed by the vehicle during the respective maneuver.

At step 708, the system aggregates portions of the vehicle state data for each maneuver to generate maneuver data for each maneuver (e.g., maneuver-level data segments 530, 532, 534). For example, the system can identify portions of vehicle state data corresponding to a maneuver and aggregate such portions to generate the maneuver data for that maneuver.

In some examples, the maneuver data for each maneuver can include any of an amount of acceleration of the vehicle, an amount of deceleration of the vehicle, an amount of change in direction of the vehicle, one or more speeds of the vehicle during the maneuver, one or more directions of the vehicle during the maneuver, one or more types of actions performed by the vehicle during the maneuver, etc. In some cases, the maneuver data for each maneuver can also include any of a timestamp(s), an amount of time and an amount of distance associated with the amount of acceleration of the vehicle, the amount of deceleration of the vehicle, the amount of change in direction of the vehicle, the one or more speeds of the vehicle during the maneuver, the one or more directions of the vehicle during the maneuver, the one or more types of actions performed by the vehicle during the maneuver, etc.

At step 710, the system determines maneuver characteristics for each maneuver (e.g., maneuver-level features 540, 542, 546) based on the maneuver data. In some examples, the maneuver characteristics can include motion information (e.g., acceleration/deceleration, position, velocity, acceleration/deceleration amount, speed, direction, distance, duration, time, etc.). In some examples, one or more maneuver characteristics of the maneuver characteristics can include a maneuver classification. The maneuver classification can identify a type of maneuver (e.g., a lane change, a stop, a turn, a u-turn, exiting a road, entering a road, etc.). In some cases, the maneuver characteristics can include vehicle states during the set of maneuvers, maneuver statistics, a context of the vehicle during one or more of the set of maneuvers, etc.

At step 712, the system generates a safety score associated with a user (and/or an operation) of the vehicle based on the maneuver characteristics. In some examples, the plurality of time periods can correspond to a plurality of trips performed by the vehicle, and each trip of the plurality of trips can correspond to a subset of time periods from the plurality of time periods.

In some examples, the safety score can be generated at least partly based on the type of maneuver associated with (e.g., identified by) one or more maneuver characteristics, statistical features in the maneuver characteristics, motion measurements, context information, and/or other information.

In some cases, the system can assign the safety score to the user and calculate a usage-based insurance cost for the user based at least partly on the safety score. In some examples, the usage-based insurance cost can include a discount or a cost increase. In some cases, the user can opt-in to a program for obtaining automotive insurance based on usage information as described above.

In some examples, the system can determine a change in speed and/or a change in direction by the vehicle during the transition from the first state to the second state. The system can then determine that the change in speed and/or the change in direction satisfies a condition for classifying vehicle activities as maneuvers, and classify the transition from the first state to the second state as the maneuver based on the satisfied condition. In some examples, the condition can include a threshold change in direction, a threshold acceleration, and/or a threshold deceleration.

In some examples, the system can learn maneuvers based on patterns identified in time-series data (e.g., vehicle state data) and statistical or machine learning processes. For example, assume the system analyzes data and identifies multiple instances where a vehicle traveled at a fairly steady speed and started to gradually slow down and drift right, followed by a small correction to the left. In this example, the changes may not be sufficient (e.g., in amount/degree, distance, and/or time) to trigger a maneuver threshold and consequently detection/identification of a maneuver for such instances. However, such activity may indicate drowsy or otherwise impaired driving. The system can detect such patterns and correlate the patterns to a maneuver and/or a risk of accident.

In some cases, the system can implement an automated feature creation tool to determine such patterns and/or maneuvers. In some examples, the automated feature creation tool can implement a neural network, subsequence-based time series clustering, stochastic selection processes, and/or other statistical or machine learning processes. The system can create maneuvers which show up in the data on a consistent basis in driving that could be indicative of driving quality. These maneuvers can be modeled with other maneuvers described above to understand the relative level of risk associated with such maneuvers.

In some cases, the maneuvers described herein can provide a context for driving behavior by relating vehicle state data (and/or associated measurements/values) to real-life activity, such as slowing to a stop or making a left turn. Maneuver characteristics can provide quantitative descriptors, which can be attached to each maneuver type, and can be used to determine and/or understand degrees of behavior (e.g., “hard” braking vs. normal braking) in the context of the real-life activity. The logical segmentation and categorization of driving activities can enable a richer and more accurate risk-predictive model.

Procedure 700 can end at step 714, but may continue on to step 704 where, as discussed above, the system receives vehicle state data. It should be noted that certain steps within procedure 700 may be optional, and further, the steps shown in FIG. 7 are merely examples for illustration—certain other steps may be included or excluded as desired. Further, while a particular order of the steps is shown, this ordering is merely illustrative and any suitable arrangement of the steps may be utilized without departing from the scope of the embodiments herein.

The techniques described herein, therefore, describe vehicle telematics processes that analyze and quantify operations of a vehicle. While there have been shown and described illustrative embodiments of a telematics system, it is to be understood that various other adaptations and modifications may be made within the spirit and scope of the embodiments herein. For example, the embodiments have been shown and described herein with relation to a specific system that organizes certain functions into modules or engines. However, the embodiments in their broader sense are not as limited, and may, in fact, be used with any number of applications, devices, and systems as part of a distributed computing network.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code.

Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving vehicle state data that includes directions and speeds of movement of a vehicle over a plurality of time periods;
determining a set of maneuvers performed by the vehicle over the plurality of time periods based on the vehicle state data, each maneuver representing a transition from a first state to a second state in a specified time period;
aggregating portions of the vehicle state data for each maneuver of the set of maneuvers to generate maneuver data for each maneuver;
determining maneuver characteristics for each maneuver based on the maneuver data, the maneuver characteristics including motion information; and
generating a safety score associated with a user of the vehicle based on the maneuver characteristics for each maneuver.

2. The method of claim 1, wherein one or more maneuver characteristics include a maneuver classification, the maneuver classification identifying a type of maneuver.

3. The method of claim 2, wherein generating the safety score is at least partly based on the type of maneuver associated with the one or more maneuver characteristics.

4. The method of claim 1, wherein the plurality of time periods is associated with a plurality of trips performed by the vehicle, and wherein each trip of the plurality of trips corresponds to a subset of time periods from the plurality of time periods.

5. The method of claim 1, wherein the maneuver characteristics comprise at least one of vehicle states during the set of maneuvers and a context of the vehicle during one or more of the set of maneuvers.

6. The method of claim 5, wherein each vehicle state of the vehicle states comprises at least one of an amount of acceleration of the vehicle, an amount of deceleration of the vehicle, an amount of change in direction of the vehicle, one or more speeds of the vehicle during a respective maneuver, one or more directions of the vehicle during the respective maneuver, and one or more types of actions performed by the vehicle during the respective maneuver.

7. The method of claim 6, wherein each vehicle state further comprises at least one of a timestamp, an amount of time and an amount of distance associated with at least one of the amount of acceleration of the vehicle, the amount of deceleration of the vehicle, the amount of change in direction of the vehicle, the one or more speeds of the vehicle during the respective maneuver, the one or more directions of the vehicle during the respective maneuver, and the one or more types of actions performed by the vehicle during the respective maneuver.

8. The method of claim 1, wherein determining the set of maneuvers comprises:
determining at least one of a change in speed and a change in direction by the vehicle during the transition from the first state to the second state;
determining that the at least one of the change in speed and the change in direction satisfies a condition for classifying vehicle activities as maneuvers, the condition comprising at least one of a threshold change in direction, a threshold acceleration, and a threshold deceleration; and
classifying the transition from the first state to the second state as the maneuver based on the satisfied condition.

9. The method of claim 1, further comprising:
assigning the safety score to the user; and
determining a usage-based insurance cost for the user based at least partly on the safety score, the usage-based insurance cost comprising one of a discount or a cost increase.

10. A system comprising:
one or more network interfaces to communicate within a communication network;
one or more processors coupled to the one or more network interfaces and adapted to executed one or more processes; and
memory configured to store a process executable by the one or more processors, the process when executed is operable to:
receive vehicle state data that includes directions and speeds of movement of a vehicle over a plurality of time periods;
determine a set of maneuvers performed by the vehicle over the plurality of time periods based on the vehicle state data, each maneuver representing a transition from a first state to a second state in a specified time period;
aggregate portions of the vehicle state data for each maneuver of the set of maneuvers to generate maneuver data for each maneuver;
determine maneuver characteristics for each maneuver based on the maneuver data, the maneuver characteristics including motion information; and
generate a safety score associated with a user of the vehicle based on the maneuver characteristics for each maneuver.

11. The system of claim 10, wherein one or more maneuver characteristics include a maneuver classification, the maneuver classification identifying a type of maneuver.

12. The system of claim 11, wherein generating the safety score is at least partly based on the type of maneuver associated with the one or more maneuver characteristics.

13. The system of claim 10, wherein the plurality of time periods is associated with a plurality of trips performed by the vehicle, and wherein each trip of the plurality of trips corresponds to a subset of time periods from the plurality of time periods.

14. The system of claim 10, wherein the maneuver characteristics comprise at least one of vehicle states during the set of maneuvers and a context of the vehicle during one or more of the set of maneuvers.

15. The system of claim 14, wherein each vehicle state of the vehicle states comprises at least one of an amount of acceleration of the vehicle, an amount of deceleration of the vehicle, an amount of change in direction of the vehicle, one or more speeds of the vehicle during a respective maneuver, one or more directions of the vehicle during the respective maneuver, and one or more types of actions performed by the vehicle during the respective maneuver.

16. The system of claim 15, wherein each vehicle state further comprises at least one of a timestamp, an amount of time and an amount of distance associated with at least one of the amount of acceleration of the vehicle, the amount of deceleration of the vehicle, the amount of change in direction of the vehicle, the one or more speeds of the vehicle during the respective maneuver, the one or more directions of the vehicle during the respective maneuver, and the one or more types of actions performed by the vehicle during the respective maneuver.

17. The system of claim 10, wherein determining the set of maneuvers comprises:
determining at least one of a change in speed and a change in direction by the vehicle during the transition from the first state to the second state;
determining that the at least one of the change in speed and the change in direction state satisfies a condition for classifying vehicle activities as maneuvers, the condition comprising at least one of a threshold change in direction, a threshold acceleration, and a threshold deceleration; and
classifying the transition from the first state to the second state as the maneuver.

18. The system of claim 10, wherein the process when executed is operable to:
assign the safety score to the user; and
determine a usage-based insurance cost for the user based at least partly on the safety score, the usage-based insurance cost comprising one of a discount or a cost increase.

19. A non-transitory computer-readable medium having software encoded thereon, the software, when executed by one or more processors, operable to:
receive vehicle state data that includes directions and speeds of movement of a vehicle over a plurality of time periods;
determine a set of maneuvers performed by the vehicle over the plurality of time periods based on the vehicle state data, each maneuver representing a transition from a first state to a second state in a specified time period;
aggregate portions of the vehicle state data for each maneuver of the set of maneuvers to generate maneuver data for each maneuver;
determine maneuver characteristics for each maneuver based on the maneuver data, the maneuver characteristics including motion information; and
generate a safety score associated with a user of the vehicle based on the maneuver characteristics for each maneuver.

20. The non-transitory computer-readable medium of claim 19, wherein the software, when executed by the one or more processors, is operable to:
assign the safety score to the user; and
determine a usage-based insurance cost for the user based at least partly on the safety score, the usage-based insurance cost comprising one of a discount or a cost increase.
